(19) United States
(12) Patent Application Publication
(10) Pub. No.: US 2005/0169170 A1
(43) Pub. Date: Aug. 4, 2005

(54) Space-efficient storage command and data routing system and method

(75) Inventor: Bahareh Ghaffari, Boulder, CO (US)

Correspondence Address: CARPENTER & KULAS, LLP, 1900 EMBARCADERO ROAD, SUITE 109, PALO ALTO, CA, 94303, US

(73) Assignee: COPAN Systems, Inc., Longmont, CO (US)

(21) Appl. No.: 11/043,877

(22) Filed: Jan. 25, 2005

Related U.S. Application Data
(60) Provisional application No. 60/540,439, filed on Jan. 30, 2004.

(51) Int. Cl. H04L 1/00

(52) U.S. Cl. 370/229

(57) ABSTRACT

An apparatus and method for space-efficient and high throughput command and data routing in data storage systems is disclosed. The apparatus comprises a host interface, a transmit circuit, a receive circuit, a plurality of storage device interfaces, and a sub-link circuit at each storage device interface. The sub-link circuit performs certain functions when the storage device is in ready phase. When the storage device enters active phase, the sub-link circuit ceases to perform one or more of the functions. These are then performed by the transmit circuit or the receive circuit.

### CLAIM OF PRIORITY

This application claims priority to the following application, hereby incorporated by reference as if set forth in full in this application:

U.S. Provisional Patent Application Ser. No. 60/540,439 entitled ‘Space-Efficient Storage Command and Data Routing System and Method’, filed on Jan. 30, 2004.

### RELATED APPLICATIONS

This application is related to the following application which is hereby incorporated by reference as if set forth in full in this specification:

Co-pending US Patent Application No. 20040205288, entitled “Method and Apparatus for Storage Command and Data Router”, filed on Apr. 12, 2004.

### BACKGROUND

The present invention relates to data storage systems. More specifically, the present invention relates to routing devices in data storage systems.

Data storage systems comprise a large number of storage devices. Data stored in these storage devices is constantly updated, added to, and retrieved by a plurality of hosts. The connection between the storage devices and the hosts is provided by a Storage Command and Data Router (SCDR). The SCDR receives commands from a host, converts the commands into a format that can be understood by a storage device and transfers the command to the storage device. The SCDR also facilitates transmission of data and commands from a storage device to a host. This communication between the hosts and the storage devices is based on serial storage protocols such as Serial Advanced Technology Attachment (SATA) or Serially Attached SCSI (SAS).

There are two proposed draft standards for the SCDR based on the SATA protocol. These proposed standards are Port Multiplier (PM) approach and Routers, Switches and Multiplexers (RSM) approach. The PM approach uses a multiplexer to multiplex host connections to up to 15 device connections. This ensures full utilization of the host's bandwidth. The PM approach requires a modification of the structure of data or command packets in SATA—referred to as the Frame Information Structure (FIS)—to enable PM routing. Consequently, either the host or the SCDR has to be modified so that an FIS that is specific to PM can be created. In the RSM approach, the commands and data to be transmitted need to be encapsulated in a wrapper FIS. All other FIS types can be encapsulated in the wrapper FIS. The wrapper FIS comprises a header that is used to define and activate a connection between route-aware devices. However, this approach requires a SATA-based host or SCDR to support RSM, in order to provide connectivity. Further, all the components of the SCDR have to be RSM route-aware and should be able to process the header, to forward the encapsulated FIS.

Consequently, SCDRs based on PM and RSM approaches require architectural changes in the host and storage devices. Further, these SCDRs have a complex design, for example, if there are ‘m’ hosts and ‘n’ storage devices, the number of multiplexers required in the SCDR are ‘m’ multiplied by ‘n’. A single failure in the connecting path between a host and a storage device can lead to disruption of traffic between the host and the storage device. SCDRs also do not allow interleaving of commands between hosts and storage devices.

### SUMMARY

In accordance with one embodiment of the present invention, an apparatus for interfacing a host to a storage device is provided. The apparatus includes a host interface, a transmit circuit, a receive circuit, a plurality of storage device interfaces, and a sub-link circuit at each of the plurality of storage device interfaces. The host interface is electrically coupled to the host. The plurality of storage device interfaces is electrically coupled with a plurality of storage devices. The transmit circuit sends a command from the host interface to the storage device interface, and the receive circuit receives data at the host interface. The sub-link circuit is present at each storage device interface and performs functions in a ready phase of communication with a host interface.

In one embodiment the invention provides an apparatus for interfacing a host device to a storage device, the apparatus comprising: a host interface electrically coupled to the host device; a transmit circuit for sending a command from the host interface; a receive circuit for receiving data at the host interface; a plurality of storage device interfaces for electrically coupling to a plurality of storage devices; and a sub-link circuit at each of the plurality of storage device interfaces, wherein a particular sub-link circuit performs functions in a ready phase of communication with a host interface, and wherein the particular sub-link circuit does not perform one or more functions necessary for an active phase of communication with a host interface.

In another embodiment the invention provides a method for routing data between a host and a plurality of storage devices, the method using a router including a plurality of sub-link circuits, the plurality of sub-link circuits performing at least one function in a ready phase of communication with a host interface, the method comprising: detecting a signal to enter an active phase of communication; and ceasing to perform one or more of the at least one function during the active phase of communication with the host interface.

A machine-readable medium including instructions executable by a processor for routing data between a host and a plurality of storage devices, wherein a router includes a plurality of sub-link circuits, the plurality of sub-link circuits performing at least one function in a ready phase of communication with a host interface, the machine-readable medium comprising: one or more instructions for detecting a signal to enter an active phase of communication; and one or more instructions for ceasing to perform one or more of the at least one function during the active phase of communication with the host interface.

### BRIEF DESCRIPTION OF THE DRAWINGS

The preferred embodiments of the invention will hereinafter be described in conjunction with the appended drawings, provided to illustrate and not to limit the invention, wherein like designations denote like elements, and in which:

FIG. 1 is a block diagram illustrating the environment in which the present invention is implemented.

FIG. 2 is a block diagram illustrating the components of a storage command and data router, in accordance with an embodiment of the present invention.

FIG. 3 is a flowchart illustrating a method of delivering commands from a host to a storage device, in accordance with one embodiment of the present invention.

### DESCRIPTION OF VARIOUS EMBODIMENTS

Data storage systems include a plurality of storage devices such as hard-disk drives, floppy drives, tape drives, compact disks, etc., for storing data. These storage devices are accessed by one or more hosts. Examples of hosts include devices such as computer servers, stand-alone desktop computers and workstations. Hosts perform read and write operations on the storage devices. Commands and data from the hosts are routed via a Storage Command and Data Router (SCDR) to the storage devices. Hosts may be connected to data storage systems through a network, such as a local area network (LAN). The transfer of commands and data in the data storage system is based on serial storage protocols such as Serial Advanced Technology Attachment (SATA), or Serially Attached SCSI (SAS).

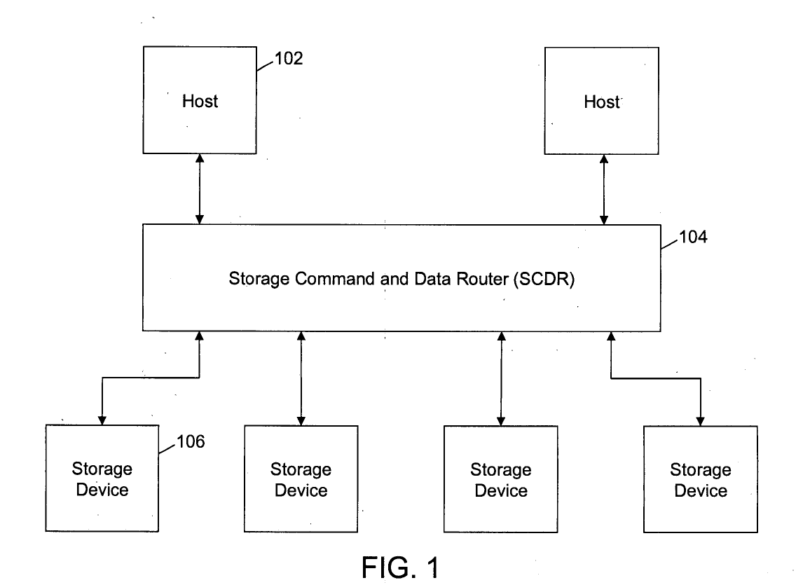

FIG. 1 is a block diagram illustrating the environment in which the present invention is implemented. The environment comprises at least one host, for example, a host 102, a storage command and data router (SCDR) 104, and at least one storage device, for example, a storage device 106. Hosts send commands and data packets to SCDR 104. SCDR 104 routes the packets to the storage devices. In case host 102 wants to send a packet to storage device 106, the packet is routed to storage device 106 through SCDR 104. Each host is queue-capable, i.e., it can transmit multiple commands to storage devices without waiting for the commands already sent to be completed. Each command includes an identifier through which the storage device to which the command is to be sent is selected by SCDR 104. The hosts may be coupled with any of the storage devices for exchange of commands, data, and status. The queue capability of the host allows for bandwidth efficiency, by having multiple storage devices active simultaneously. The storage device may optionally be queue capable or non-queue capable. In one embodiment of the present invention, SCDR 104 is implemented as a single semiconductor chip. For example, SCDR 104 may be implemented as a Field Programmable Gate Array (FPGA) or an Application Specific Integrated Circuit (ASIC).

Serial bit streams in a serial storage protocol are referred to as packets. Packets exchanged in the above-described system are defined by serial storage communication protocols such as Serial Advanced Technology Attachment (SATA) and Serially Attached SCSI (SAS). These protocols define the transfer of data, commands, and status between hosts and storage devices in the form of serial bit streams. A packet based on the SATA protocol is in the form of a Frame Information Structure (FIS). For the purpose of illustration, the invention has been described with the help of serial bit streams based on the SATA protocol. However, other serial storage protocols are equally applicable for the present invention.

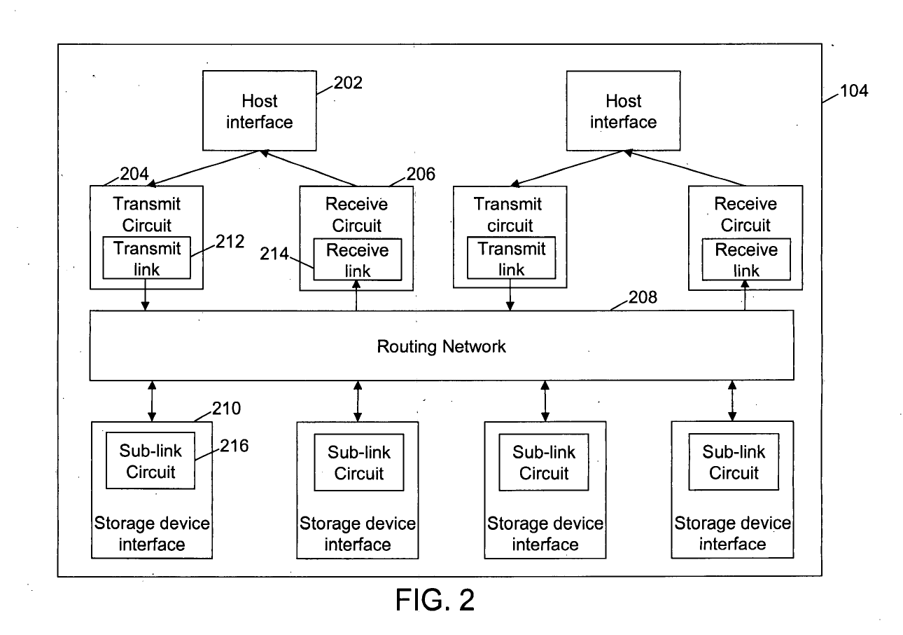

FIG. 2 is a block diagram illustrating the components of SCDR 104, in accordance with one embodiment of the present invention. SCDR 104 comprises at least one host interface, for example, host interface 202; a transmit circuit, for example, transmit circuit 204; a receive circuit, for example, a receive circuit 206; a routing network 208; and at least one storage device interface, for example, a storage device interface 210. Each transmit circuit comprises a transmit link, for example, transmit circuit 204 comprises transmit link 212. Similarly, each receive circuit comprises a receive link, for example, receive circuit 206 comprises receive link 214. Transmit and receive circuits are further explained in US patent application number 20040205288, entitled “Method and Apparatus for Storage Command and Data Router”, filed on Apr. 12, 2004, and assigned to Copan Systems, Inc. On the other hand, each storage device interface comprises a sub-link circuit, for example, storage device interface 210 comprises sub-link circuit 216. There is one host interface corresponding to each host and is electrically coupled to the host. Similarly, there is one storage device interface corresponding to each storage device and is electrically coupled to the storage device. There is a transmit and a receive circuit pair per host interface. The host interfaces have standard SATA physical layers, and SATA link layers. Details of SATA layering architecture can be obtained from ‘Serial ATA: High Speed Serialized AT Attachment’, Revision 1.0A published by the Serial ATA Workgroup on Jan. 7, 2003. Host interfaces handle the traffic of incoming and outgoing packets to the corresponding hosts; for example, host interface 202 handles the traffic of incoming and outgoing packets to host 102. Transmit circuit 204 and receive circuit 206 perform the necessary functions for decoding received FISs. In the present invention, the SATA standard link is divided to a single transmit link per host, a single receive link per host, and a multitude of sub-links, one per storage device interface. This division of labor allows for simultaneous receipt of an FIS from the device, and transmission of an FIS to a different device when allowed by the communication protocol. The sub-link circuits allow SCDR 104 to comprise a single transmit and receive logic gate per host by locally handling the serial communication with the storage device interfaces (referred to as ready phase) and entering active state when signaled by routing network 208 (referred to as active phase). In active phase, the sub-link circuits allow for direct communication of the receive or transmit links with the storage device interfaces. In ready phase, the sub-link circuits generate the minimal functions necessary to keep the storage devices in proper state. A storage device interface is said to be in active phase when routing network 208 establishes a connection between a transmit or receive link and the sub-link circuit in the storage device interface coupled to the storage device. A storage device interface is said to be in ready phase when the logic in the sub-link in the storage device interface coupled with the storage device is running the communication protocol with the storage device.

When a host interface receives a packet, the transmit circuit corresponding to the host interface decodes the packet and selects the storage device to which the packet is to be routed. Each transmit link comprises all the functionality of a link interface, as described in the SATA standard, that is pertinent to transmission of an FIS. After selecting the storage device, the transmit circuit sends a request for connection with the storage device to routing network 208; for example, transmit circuit 204 sends a request for connection with storage device 106 to routing network 208 for transmitting a command received from host 102 to storage device 106. Routing network 208 then signals the sub-link circuit corresponding to the storage device to exit ready phase and enter active phase. During ready phase, sub-link circuits generate random data of a known ending disparity. Just before entering active phase, sub-link circuits ensure that the last character sent maintains the last disparity transmitted by the transmit link. The disparity of the first character transmitted by the transmit circuit is of the same disparity as the last character transmitted by the sub-link circuit before entering active phase. Once in active phase, the transmit link locks its incoming disparity with the first received primitive and checks the disparity of every received primitive after that. Routing network 208 multiplexes the serial bit stream from the transmit link to the sub-link. This multiplexing is done with the help of an opening window between the transmit link and sub-link. The transmit link then completes the transmission of the FIS to the coupled storage device. Just before the transmission of the packet is complete and the connection between the transmit link and the sub-link circuit is terminated, the transmit link ensures that the last primitive of the communication protocol is transmitted and that random data is generated by the transmit link. When the connection is terminated and the sub-link circuit enters ready phase, the sub-link circuit locks onto the disparity of the last character transmitted and maintains the disparity by generating random data that does not change the disparity of the last character transmitted.

When a storage device wants to send a packet to a host, the sub-link circuit corresponding to the storage device interface decodes an X_RDY_{P} primitive with either disparity, and signals a request to receive to the receive circuit corresponding to the host, through routing network 208. Each receive link comprises all the functionality of a link interface, as described in the SATA standard, that is pertinent to receiving an FIS. Receive circuits comprise an arbiter to select the next receive FIS. The receive circuit arbitrates requests obtained from various sub-link circuits through routing network 208. This is based on an arbitration algorithm, which decides which of a plurality of requests for connections is to be addressed first. An example of an arbitration algorithm can be selecting connections in the sequence of requests received for connections. Another example can be giving priority to connections directed to storage devices that are in ready phase. On selecting a storage device, the receive circuit signals routing network 208. Routing network 208 then signals the sub-link circuit corresponding to the selected storage device to enter active phase. During the ready phase and just before entering active phase for receive operation, the sub-link circuit maintains the disparity last transmitted. Once in active phase for receiving, the packets from the receive link are forwarded to the storage device through routing network 208 and through the storage device interface. The receive link waits for the first primitive from the storage device to lock on to the new disparity. Once the disparity is locked by the receive circuit, it is checked after the receipt of every character. Just before the connection is to be terminated and the storage device interface is to return to ready phase, the receive circuit ensures that the last character transmitted is of a known disparity and the sub-link locks onto that disparity and maintains it by generating random data that does not change the ending disparity.

Routing network 208 facilitates the packet transfers between any transmit circuit or receive circuit and any storage device interface. In one embodiment of the invention, routing network 208 comprises a plurality of multiplexers, which enable connection between any transmit or receive circuit with any storage device interface. Routing network 208 connects a plurality of storage device interfaces with a plurality of receive circuits and/or transmit circuits. For transmission of an FIS, the routing of the FIS to a specific storage device interface is determined by the FIS itself (if the FIS is a command) or the transaction referred by the previous command FIS. If the current FIS is a data FIS the previous command referring to transmit of the FIS determines which storage device interface is selected. Thus, for transmit of an FIS, routing network 208 multiplexers, multiplex the FIS from the transmit link to the sub-link of the selected storage device. For receipt of an FIS, routing network 208 forwards the request to receive to the receive circuit which arbitrates for the next receipt of the FIS. Routing networks are further explained in US patent application number 20040205288, entitled “Method and Apparatus for Storage Command and Data Router”, filed on Apr. 12, 2004, and assigned to Copan Systems, Inc.

Sub-link circuits perform various functions when the corresponding storage devices are in ready phase, i.e., when the storage devices are not exchanging FISs with any host. These functions include generation of random data, sampling and registering of X_RDY_{P} and power management primitives, detecting the loss of X_RDY_{P} and power management primitives, and generation of ALIGN primitives.

In accordance with another embodiment of the invention, sub-link circuits execute a process to generate random data. This process of random data generation is used to enter and exit active phase. The random data is exchanged between a transmit or receive link and a sub-link. The random data of a known disparity provides a window for the transmit or receive link to multiplex its data along with the data generated by the sub-link circuit. The sub-link data then maintains that disparity during the ready phase. Further, the random data helps in reducing Electro-Magnetic Interference (EMI), as defined in the SATA standard. When the storage device is exiting active phase and entering ready phase, the sub-link circuit locks onto the ending disparity of the data received from the transmit or receive link. Similarly, when a connection is about to be established, the sub-link circuit ensures that the last random data transmitted is of a known ending disparity. The transmit or receive link locks on to the disparity of the last random data received from the sub-link circuit. Hence, the disparity of data is continued.

In accordance with another embodiment of the invention, sub-link circuits execute a process that detects the generation of power management primitives from a storage device. On detecting power management requests from a storage device, a sub-link circuit informs routing network 208 of such a request. When a storage device is not in active state, the sub-link circuit negotiates via power management primitives to power down the storage device. This helps in optimizing the power consumption of the system without involving any hosts.

In accordance with another embodiment of the invention, sub-link circuits execute a process that detects any loss in power management primitives due to an error in connection. In this case, sub-link circuits notify routing network 208 of a loss of communication during a power management handshake. This error condition is signaled to the host with which the connection exists, by setting a status bit in SCDR 104.

In accordance with another embodiment of the present invention, sub-links execute a process for registering X_RDY primitives. As mentioned above, when a storage device wants to send a packet to a host device, the sub-link corresponding to the storage device registers an X_RDY_{P} primitive to denote a request for communication from the storage device. Receive links arbitrate between the various requests received from sub-link circuits. Therefore, the response to these primitives can be delayed till when the receive circuit wishes to receive packets from the storage device.

In accordance with another embodiment of the present invention, sub-link circuits execute a process for detecting loss of X_RDY primitives. If a request is lost before it is processed, sub-link circuits inform SCDR 104, which registers this error condition.

In accordance with one embodiment of the present invention, sub-link circuits execute a process to generate ALIGN primitives. When a storage device is in ready phase, the sub-link circuit corresponding to the storage device generates ALIGN primitives to the storage device. If a connection is required between the storage device interface and either one of a transmit circuit or a receive circuit while the sub-link interface is generating and transmitting ALIGN primitives, the connection is delayed till after the transmission of the ALIGN primitives is complete. When a connection is established between a host interface and the storage device corresponding to a sub-link circuit, i.e., the storage device interface enters active phase, ALIGN primitives are generated by the transmit link or the receive link corresponding to the host interface.

Host interfaces and storage device interfaces synchronize their operating clocks with storage device interfaces by including or dropping ALIGN primitives, and maintain an elasticity buffer. The elasticity buffer compensates for differences in clock frequencies between SCDR 104 and the storage devices. However, other approaches for compensating for differences in clock frequencies between the circuits may also be used.

Although specific protocols and standards, such as SATA, have been discussed, embodiments of the invention can be used with other suitable protocols, standards or communication approaches (e.g., SAS, etc.) whether presently known or later developed.

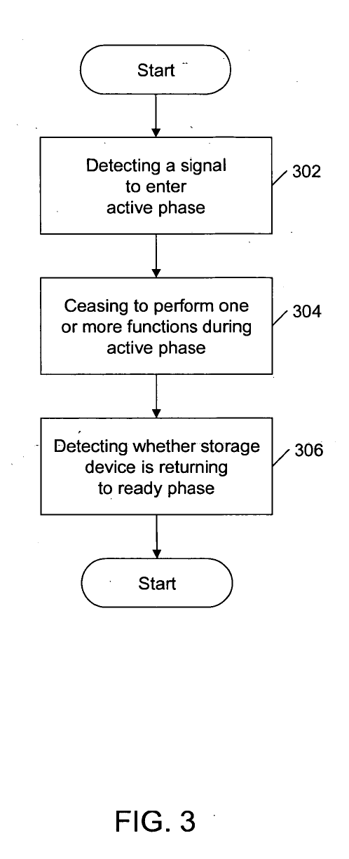

FIG. 3 is a flowchart illustrating the method of delivering commands and data from a host to a storage device, in accordance with an embodiment of the present invention. For illustration purposes, the method is explained with the help of the example cited above, wherein host 102 wants to send a command to storage device 106, while storage device 106 is in ready phase. At step 302, sub-link circuit 216 detects a signal from routing network 208 to enter active phase of communication. If the storage device interface is entering active phase, sub-link circuit 216 ceases to perform one or more functions that it performs during ready phase of storage device 106, at step 304. For example, during active phase sub-link circuit 216 does not generate ALIGN primitives and does not generate random data. In active phase, these functions are performed by transmit link 212 or receive link 214. At step 306, sub-link circuit 216 detects if storage device 106 is returning to ready phase, i.e., the connection between host 102 and storage device 106 is being terminated. If storage device 106 is returning to ready phase, sub-link circuit 216 starts performing the various functions.

The embodiments of the present invention have the following advantages. The transmit and receive circuits operate independently of each other. Therefore, packets can be processed at the same time, thereby increasing the throughput of the system. This invention allows for a system with multiple host and multiple devices to coexist as part of a single controller. In this invention, the number of transmit and receive links is equal to the number of hosts, and not number of storage devices. Therefore, the number of gates required to implement the system is reduced, since the number of hosts is usually less than the number of storage devices.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “process”, as used in this patent application, can be executed by a “processor”. A processor includes any human, hardware and/or software system, mechanism, or component that processes data, signals, or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Moreover, certain portions of processing can be performed at different times and at different locations, by different (or the same) processing systems.

Reference throughout this specification to “one embodiment”, “an embodiment”, “another embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, “in another embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. In addition, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes, and substitutions are intended in the foregoing disclosures. It will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

1. An apparatus for interfacing a host device to a storage device, the apparatus comprising:
a host interface electrically coupled to the host device;
a transmit circuit for sending a command from the host interface;
a receive circuit for receiving data at the host interface;
a plurality of storage device interfaces for electrically coupling to a plurality of storage devices; and
a sub-link circuit at each of the plurality of storage device interfaces, wherein a particular sub-link circuit performs functions in a ready phase of communication with a host interface, and wherein the particular sub-link circuit does not perform one or more functions necessary for an active phase of communication with a host interface.

2. The apparatus of claim 1, further comprising a routing network coupled between the host interface and the storage device interfaces.

3. The apparatus of claim 1, further comprising a process within the particular sub-link circuit for generating an ALIGN communication.

4. The apparatus of claim 1, further comprising a process within the particular sub-link circuit for generating random data.

5. The apparatus of claim 4, wherein the random data reduces electromagnetic interference.

6. The apparatus of claim 4, wherein the random data includes a known ending disparity.

7. The apparatus of claim 4, wherein the random data provides a window for multiplexing data during the active phase.

8. The apparatus of claim 7, further comprising a process within the particular sub-link for continuing disparity of data.

9. The apparatus of claim 1, further comprising a process within the particular sub-link circuit for registering power management primitives.

10. The apparatus of claim 9, wherein a Serial Advanced Technology Attachment (SATA) protocol includes an X_RDY signal definition, the apparatus further comprising a process within the particular sub-link circuit for processing an X_RDY signal.

11. The apparatus of claim 10, further comprising a process within the particular sub-link circuit for detecting loss of the X_RDY signal.

12. The apparatus of claim 1, wherein a Serially Attached SCSI (SAS) protocol is used.

13. The apparatus of claim 1, wherein the recited elements are formed on a single semiconductor chip.

14. The apparatus of claim 1, wherein each host interface includes transmit and receive circuits.

15. A method for routing data between a host and a plurality of storage devices, wherein a router includes a plurality of sub-link circuits, the plurality of sub-link circuits performing a function in a ready phase of communication with a host interface, the method comprising:
detecting a signal to enter an active phase of communication; and
ceasing to perform the function during the active phase of communication with the host interface.

16. The method of claim 15 further comprising:
detecting whether the storage device is returning to the ready phase of communication.

17. The method of claim 15, further comprising:
sending data to reduce electromagnetic interference.

18. A machine-readable medium including instructions executable by a processor for routing data between a host and a plurality of storage devices, wherein a router includes a plurality of sub-link circuits, the plurality of sub-link circuits performing a function in a ready phase of communication with a host interface, the machine-readable medium comprising:
one or more instructions for detecting a signal to enter an active phase of communication; and
one or more instructions for ceasing to perform a function during the active phase of communication with the host interface.

19. The machine-readable medium of claim 18 further comprising:
one or more instructions for detecting whether the storage device is returning to the ready phase of communication.

20. The machine-readable medium of claim 18, further comprising:
one or more instructions for sending data to reduce electromagnetic interference.
